(19) United States
(12) Patent Application Publication
(10) Pub. No.: US 2025/0325164 A1
(43) Pub. Date: Oct. 23, 2025

(54) HAND FREE FOOTWEAR AND FOOT CLEANING DEVICE

(71) Applicant: John Marshall Tendall, Longboat Key, FL (US)

(72) Inventor: John Marshall Tendall, Longboat Key, FL (US)

(21) Appl. No.: 19/258,116

(22) Filed: Jul. 2, 2025

Related U.S. Application Data
(63) Continuation-in-part of application No. 18/937,297, filed on Nov. 5, 2024.
Application No. 18/937,297 is a continuation of application No. 17/564,722, filed on Dec. 29, 2021, now Pat. No. 12,133,621.
(60) Provisional application No. 63/158,003, filed on Mar. 8, 2021.

(51) Int. Cl. A47L 23/02; A47K 7/04; B05B 1/20; G01V 8/10

(52) U.S. Cl. CPC A47L 23/02; A47K 7/046; B05B 1/205; G01V 8/10

(57) ABSTRACT

A hands-free footwear and foot cleaning device which allows the user to clean the bottom or the sole of the footwear as well as the exterior surrounding sides of the footwear. The device can also be used to clean a user's bare foot. The device utilizes a plurality of rollers and a series of water line sprayers that are adapted to spray in a direction to contact one or more of the side portion, bottom portion, or top portion of the sole of a footwear or foot. The sprayers are activated by either a sensor or a pressure devise. The device may also include the option of incorporating additional elements for the purpose of cleaning bare feet rather than just the bottoms of the footwear.

### PRIORITY

This application is a continuation-in-part of U.S. application Ser. No. 18/937,297 filed on Nov. 5, 2024 which is a continuation of U.S. application Ser. No. 17/564,722 filed Dec. 29, 2021, issued as U.S. Pat. No. 12,133,621 on Nov. 5, 2024, which claims priority to provisional patent application 63/158,003 filed on Mar. 8, 2021.

### FIELD OF THE INVENTION

The present invention relates to a hand free footwear and foot cleaning device which allows the user to clean the bottom or the sole of the footwear as well as the exterior surrounding sides of the footwear. The device can also be used to clean a user's foot. The present invention further provides for a decreased need for movement of the foot during the cleaning process. The present invention also includes the option of incorporating additional elements for the purpose of cleaning bare feet rather than just the bottoms of the footwear. Further the present invention includes a housing configured to protect the nozzles whereby the nozzles are removeable form the housing for maintenance and repair.

### BACKGROUND OF THE INVENTION

One of the most significant issues within the footwear industry is combating the inevitable accumulation of different contaminants and debris on the exterior sides of the footwear, as well as in the exterior sole. This is especially true when the footwear is used on clay or synthetic surfaces on tennis courts. Various debris such as dirt, mud, salt, particulates, and other undesired material are collected on the exterior surface of the footwear with regular use. Such unwanted elements, over time, diminish the appearance, material, and overall structure of the footwear. The unwanted material can also be tracked into a car or house. Because of this, footwear cleaning devices have become vital in combatting the continual buildup of unwanted contaminants on exterior footwear surfaces.

To prevent such issues, innovators have created footwear-cleaning devices which allow for the user to place their foot in the device while wearing footwear and move their foot back and forth within the device's housing to clean the exterior sole and sides of the footwear.

The present invention will improve upon the above-mentioned needed areas of progress for hand free footwear cleaning device. Factors such as the amount of foot movement needed to clean the footwear, the amount of surface-area that a device can cover, and the amount of time required to complete the footwear cleaning process are addressed by the present invention. The present invention will demand significantly less movement of the foot than the current devices require. The present invention will also clean a greater surface area of the footwear than the current devices are capable of. Lastly, the present invention will decrease the amount of time required to thoroughly clean the footwear. In addition, the invention may provide a hand free activation feature, allowing the device to begin operating upon the placement of the footwear inside of the housing of the device.

### SUMMARY OF THE INVENTION

The present invention relates to a hand free footwear cleaner by using a plurality of rows of sprayers as opposed to just a single row of sprayers, and a plurality of rows of rollers as opposed to just a single row of rollers, enabling a decreased amount of movement of the footwear required for the sprayers and rollers of the device to reach and interact with the exterior sole and side surfaces of the footwear.

The present invention utilizes a pressure activation to initiate the spray, or it may use a sensor to activate the spray. The presence of a sensor to activate the flow of water allows for hand free operation that eliminates the transfer of bacteria and other germs that is caused by numerous users touching a control to turn on and off the flow of water of a device.

The present invention includes a handrail to help maintain the balance of a user.

The present invention further includes a protective housing to protect the nozzles from accidental contact by a user and a the ability to remove the nozzle configuration form the housing.

The present invention further includes a grate system positioned between the rollers and the and the collection area to help prevent debris such as leaves, trash or the like from entering the nozzle area and the collection area.

The present invention also incorporates the ability to clean bare feet, by targeting sprayers towards the top of the foot in addition to the sides and sole.

### BRIEF DESCRIPTION OF THE DRAWINGS

FIG. 1 is a side view of an embodiment of the hand free footwear and foot cleaning device;

FIG. 2 is a view of an embodiment the hand free footwear and foot cleaning device;

FIG. 3 is a perspective view of an embodiment of the hand free footwear and foot cleaning device;

FIG. 4 is a bottom view of the sole of a shoe containing unwanted contaminants and debris;

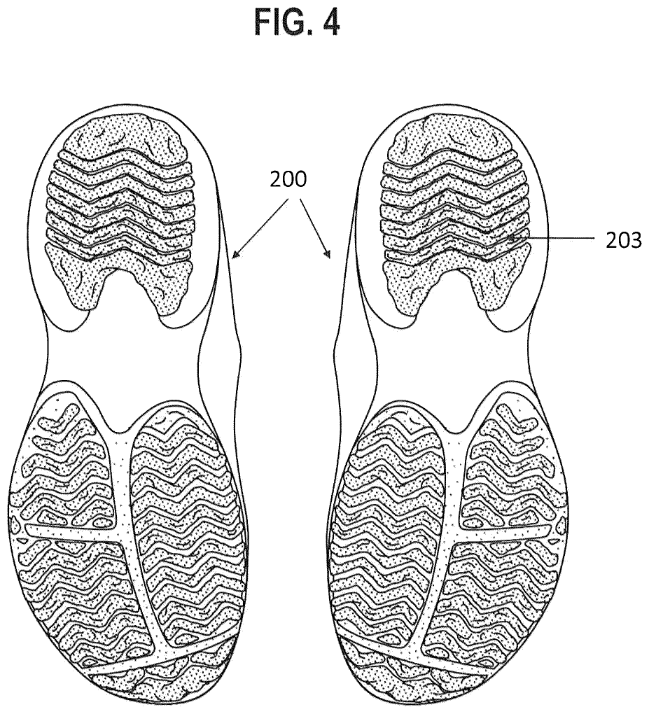

FIG. 5 is a bottom view of the sole of a shoe after the shoe has received treatment from the device of the present invention.

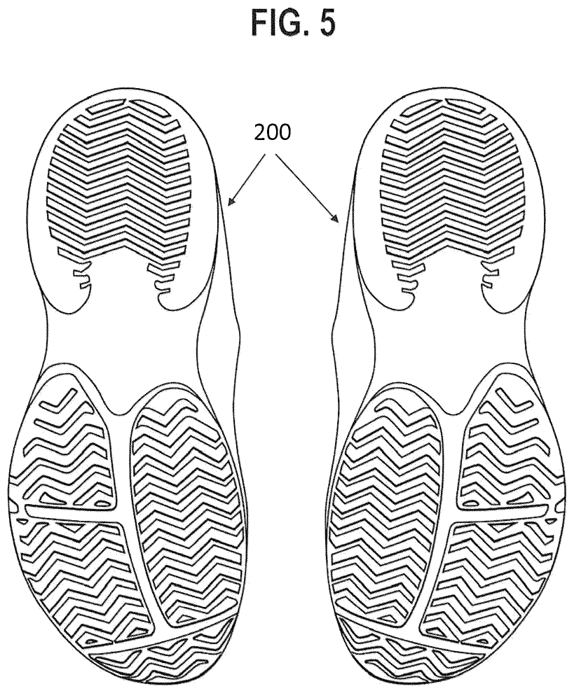

FIG. 6 is a perspective view of the hand free footwear and foot cleaning device depicting a handlebar for a user to grasp for support while using the device.

FIG. 7 is a perspective view of an alternative embodiment of the hand free footwear and foot cleaning device depicting a housing and removeable nozzle configuration of the device.

FIG. 8 is a top view of an alternative embodiment of the hand free footwear and foot cleaning device depicting a housing and removeable nozzle configuration of the device.

FIG. 9 is a bottom view of an alternative embodiment of the hand free footwear and foot cleaning device depicting a housing and removeable nozzle configuration of the device.

### DETAILED DESCRIPTION OF THE PREFERRED EMBODIMENTS OF THE INVENTION

The following descriptions of the preferred embodiments of the present invention for a hand free device for cleaning a user's footwear or foot are intended to be exemplary of the preferred manner to practice the invention and are not intended to limit the scope of invention in any manner.

The hand free footwear and foot cleaning device allows for a user to clean the bottom and/or sides of any footwear worn by user, or the user's foot (if no footwear is being worn) without requiring the user to contact the device or any mechanism to activate the device without requiring the user to activate the device using their hands. The device activation device could comprise a pressure activation or sensor, such as a photosensor.

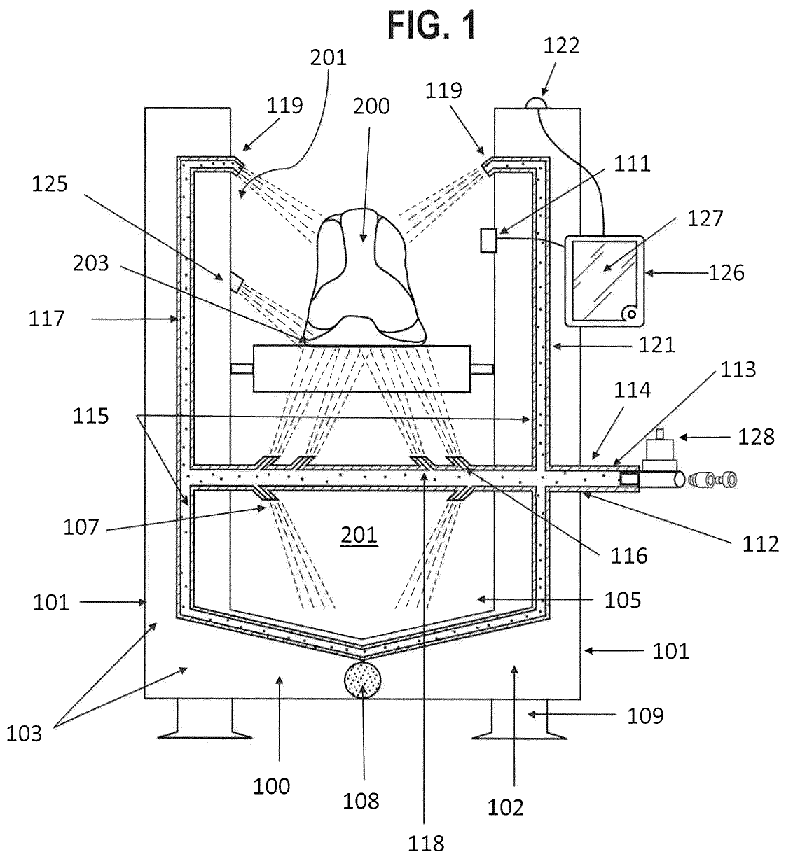

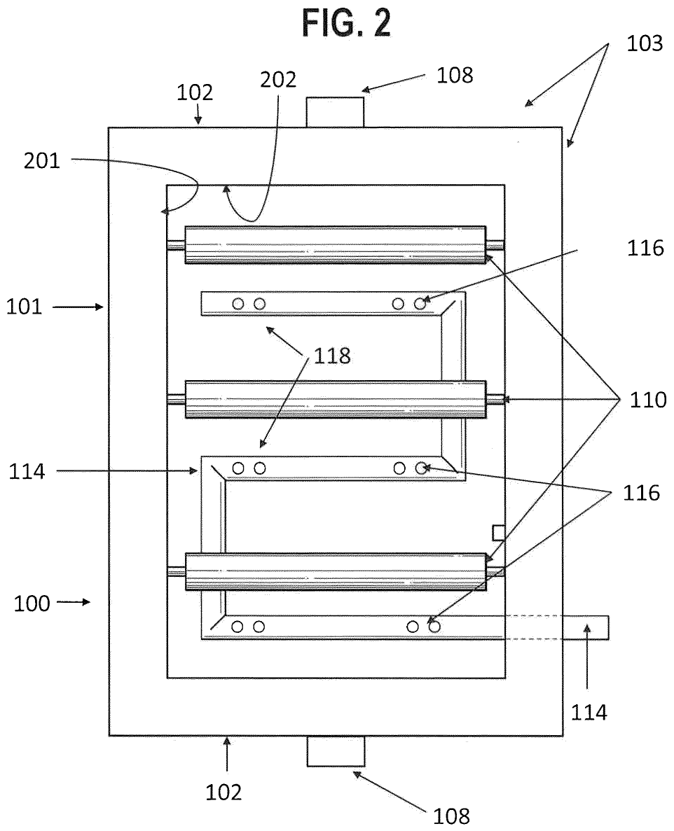

As can be seen from the FIGS. 1-3, the present invention embodies a rectangular base 100, with a heightened wall 101 extending vertically from each lengthier side of the base 100, and a smaller wall 102 on each adjacent side of the base 100. The base 100 may be rectangular or any shape desirable, so long as it is able to accommodate the foot of a user. The walls 101 and the base 100 comprise the main housing 103. The main housing 103 is shown as rectangular in FIGS. 1 and 2. It should be understood that the housing 103 may be manufactured in any shape and may also be configured to accommodate decorative elements if it is so desired. The main housing 103 may be made out of plastic, PVC, rubber, metal or any other suitable material that is capable of withstanding the demands of the cleaning device. It should be applicated by those of ordinary skill in the art that the housing 103 may be constructed from one unitary piece from an injection molding process, or the housing 103 could be constructed of numerous components. The heightened wall 101 and the smaller wall 102 may be configured to accommodate a decorative side panel.

The base 100 may also encompass a sunken basin 105 for the purpose of collecting either liquid or other debris that falls in result of the cleaning process or the sunken basin 105 could collect both. The heightened wall 102 and smaller wall 101 have an interior surface 201 and 202. The surface of the sunken basin 105 may be angled in a direction that will enable water to flow towards the drain 108. It is possible to place a filter in the sunken basin 105 to separate particulates from the water. The base 100 may also include a cleanout opening 108 facing horizontally and outwardly from the exterior of one of the smaller walls 102, and a drain-opening 108 facing outwardly and horizontally from the exterior of the opposite smaller wall 102 of the base 100. The base 100 may be elevated from the ground by supports 109 attached at each corner of the bottom of the base 100. The supports 109 may be of plastic, rubber or the same material.

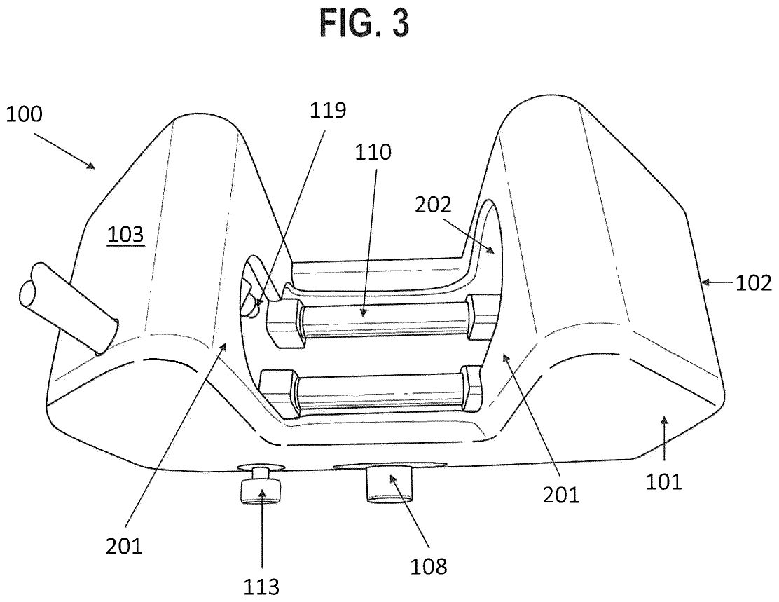

A plurality of rollers 110 can be seen in FIGS. 1, 2 and 3. A plurality of rollers 110 may be attached to the inside of each heightened wall 101 in a plurality of horizontally parallel intervals. The rollers 110 may be positioned horizontally approximately along the center of the main housing 103. It should be appreciated that the number of rollers 110 is not limited to the three rollers as shown in FIG. 2 or two rollers as shown in FIG. 3. The number of rollers 110 is not an important feature of the present invention. Each of the rollers 110 may be connected from the interior of one of the heightened walls 101 to the interior of the opposite heightened walls 101. The rollers 110 may be designed to spin when frictionally engaged with the footwear 200 or foot. It should be appreciated that reference made to footwear 200 should also include the foot of a user if the user is not wearing footwear. The rollers 110 may alternatively be ball bearings. The rollers 110 may be configured to activate a sensor 111 which is present within one of the heightened walls 101 of the housing 103 detects the presence of a foot or footwear 200 within the housing 103 of the device. The rollers 110 may be configured to employ a contact sensor (not shown). There may also be a pressure contact sensor (not shown) on the rollers 110 which operate to activate the valve 128, described in more detail below, when pressure is placed on the roller 110 by the footwear 200. A person of ordinary skill in the art would understand the type of contact sensor which could be employed as part of the rollers 110.

An opening 112 may be present on the exterior of one heighted wall 101, at a position vertically below the rollers 110. The opening 112 may be adapted to attach to a quick connector 113 on the exterior heighted wall 101. An interior water line 114 can be seen in FIGS. 1-2. The interior water line 114 may run through the opening 112 in the heightened wall 101 and may be adapted to attach to and work in connection with the quick connector 113. The water line 114 may have several extensions 115. The first water line 114 may run from the opening in the interior heightened wall 101. The first water line 114 may lay horizontally underneath where the rollers 110 are present, and above the sunken clean-out housing. The first water line 114 may travel horizontally above the center of the sunken basin 105 of the device, and snake in a right-angled fashion (shown in FIG. 2), to reach areas where the water line containing sprayer nozzles 116 interacts with the bottom of the exterior surface of the footwear 201 or the exposed foot if no footwear is worn by the individual. The first water line 114 may be configured to be positioned between the rollers 110 so as to not be blocked by the above rollers 110.

The device may encompass a second water line extension 117, as can be seen in FIG. 1. There is a water line 115 may extend horizontally at a height above one end of a smaller wall 102 but below the rollers 110. The second water line extension 117 may also extend at a right angle 118 upwards after reaching the opposite heightened wall 101 from which it started. The second water line 117 may extend to nearly the top of the heightened wall 101. The second water line 117 extending at a right angle 118 may extend slightly inward towards the center of the device housing 103 where an attached sprayer 119 may be angled downwards towards the side surface of where the footwear or foot will be placed 120 in the devise during operation. It should be understood that nozzles 119 should only be implemented in a device that operates on the bare foot of a user rather than on footwear because it is undesirable to spray the top of a shoe while it may be desirable to spray the top of a bare foot. All the nozzles 116, The second water line 117 may operate to remove debris from the bottom of the sole of the footwear 200 or foot. The second water extension 117 may be positioned between the rollers 110 so that the rollers 110 do not interfere with the sprayer 119 toward the sole of the footwear 200. The device may be designed for the user to allow or restrict water from flowing from the upper sprayer 119.

The device may encompass a third water line extension 121, as can be seen in FIGS. 1-2. The third water line extension 121 may extend vertically across the same heightened wall 101 in which the water line 114 entered and may extend to nearly the top of that wall where it reaches a right angle and extends slightly inward towards the center of the device housing where an attached sprayer 119 may be angled downwards towards the side surface of where the footwear or foot will be placed 120 in the devise during operation. The third water line extension 121 may be positioned between a set of rollers 110 such that the roller 110 does not interfere with the sprayer 116 angled toward the bottom of the footwear 200 or foot. The device may be designed for the user to adjust the flow from sprayer 119 to either allow or restrict water from flowing from the upper sprayer 119.

The present invention may encompass a plurality of rollers 110 that support the sole of the footwear 200 or the base of the foot. Each of the first 114, second 117 and third 121 water line extensions may include at least a first spray nozzle 116, a second spray nozzle 118, and a third spray nozzle 119 but can include numerous spray nozzles if desired. The sprayer(s) 119 of the first, second and third water line extensions may be positioned in a fashion that the roller 110 does not interfere with the water jet propelled through the sprayers 119, 116 and 118. While the drawings show three water lines each having one or more sprayers 119, 116 and 118 at each end, the water lines can be placed in numerous different configurations which operate to clean the footwear 200. Likewise, the number of sprayers 119, 116 and 118 attached to each line is not essential to the invention. The invention could also include a set of sprayers 107 that operate to clean the sunken basin 105.

The present invention may also encompass a fourth sprayer 125 configured to spray water in a position along the side sole of the footwear 200 or foot. While FIG. 1 depicts the fourth sprayer 125 on only one side of the footwear 200, it should be understood that there may be a fourth sprayer positioned on the opposite side of the footwear 200 from the fourth sprayer 125 similar to the manner the sprayers 119 are depicted in FIG. 1. It is important that the spray from the fourth sprayer 125 spray the sole of the footwear 200 and not actually spray the upper part of the footwear 200 with water. It is not desirable spray the upper part of the footwear in a manner that would soak the upper portion of the footwear 200. Although not required, the fourth sprayer 125 nozzle is typically positioned to spray in an angled-downward direction so as to prevent the water from contacting the top surface of the footwear 200.

The device may encompass an option to provide a feature that cleans the top surface of a foot placed in the device. This option may be used at beaches, swimming pools or other areas that it is desirable to clean the top surface of the foot as well as the bottom and sides of the foot.

A fifth water line (not shown) may be added to the apparatus described above. A fifth water line extension may operate to clean the top surface of the foot when placed in the device of the current invention. There may be additional sprayers 119 placed above the rollers 110, and aimed towards the top of the foot and exist in a plurality of intervals horizontally across the interior walls of the heightened walls 101, and work in congruence with water lines present along each heightened wall 110, and a plurality of sprayers 119 angled towards the sunken housing 105 to assist in loosening/cleaning debris from the housing 103.

A waterproof housing 126 may contain a battery 127 which operates the valves of the device. The waterproof housing 126 may be fixed to the side of one of the heightened walls 101. While a battery 127 is the preferred power source, numerous different power sources may be use without departing from the spirit of the invention. There may be a low battery light 122 fixed to the top of same heightened wall 101 where the battery housing 126 is present, for the purpose of notifying the user that the battery 127 is running low, and the lower battery light may operate in congruence with the battery. The sensor 111 may be powered by ac power.

The footwear cleaning device of the present invention may include a valve 128 which opens to allow the flow of water into the water line extensions 112, 117, 118 and 121. The valve 128 may be a standard T-valve that is operated manually. Alternatively, the device may include a photocell (as part of sensor 111) fixed internally to the same heightened wall 101 where the battery housing 126 is fixed and works in connection with the battery 127. The device could also be powered by AC power if desired. The photocell 111 may sense the presence of the footwear 200 or foot within the main housing 103 of the device. The photocell 111 may send a signal to a solenoid which opens the valve when the footwear 200 or foot is detected. The photocell may signal the device to operate when the footwear 200 or foot enters the main housing 103, and to cease operating when the footwear 200 or foot is removed from the main housing 103. The device could alternatively be programmed to automatically cease operating after a desired period of time, such as thirty seconds. In addition to the photocell described above, the valve could alternatively be controlled by pressure sensors built into the rollers 110. In such a configuration, the rollers 110 may include a pressure sensor (not shown) such that when pressure is applied to one of the rollers 110, the sensor operates to open the valve 128.

As can be seen from the FIGS. 1-3, the present invention embodies a rectangular base 100, with a heightened wall 101 extending vertically from each lengthier side of the base 100, and a smaller wall 102 on each adjacent side of the base 100. The base 100 may be rectangular or any shape desirable, so long as it is able to accommodate the foot of a user. The walls 101 and the base 100 comprise the main housing 103. The main housing 103 is shown as rectangular in FIGS. 1 and 2. It should be understood that the housing 103 may be manufactured in any shape and may also be configured to accommodate decorative elements if it is so desired. The main housing 103 may be made out of plastic, PVC, rubber, metal or any other suitable material that is capable of withstanding the demands of the cleaning device. It should be applicated by those of ordinary skill in the art that the housing 103 may be constructed from one unitary piece from an injection molding process, or the housing 103 could be constructed of numerous components. The heightened wall 101 and the smaller wall 102 may be configured to accommodate a decorative side panel.

The base 100 may also encompass a sunken basin 105 for the purpose of collecting either liquid or other debris that falls in result of the cleaning process or the sunken basin 105 could collect both. The heightened wall 102 and smaller wall 101 have an interior surface 201 and 202. The surface of the sunken basin 105 may be angled in a direction that will enable water to flow towards the drain 108. It is possible to place a filter in the sunken basin 105 to separate particulates from the water. The base 100 may also include a cleanout opening 108 facing horizontally and outwardly from the exterior of one of the smaller walls 102, and a drain-opening 108 facing outwardly and horizontally from the exterior of the opposite smaller wall 102 of the base 100. The base 100 may be elevated from the ground by supports 109 attached at each corner of the bottom of the base 100. The supports 109 may be of plastic, rubber or the same material.

A plurality of rollers 110 can be seen in FIGS. 1, 2 and 3. A plurality of rollers 110 may be attached to the inside of each heightened wall 101 in a plurality of horizontally parallel intervals. The rollers 110 may be positioned horizontally approximately along the center of the main housing 103. It should be appreciated that the number of rollers 110 is not limited to the three rollers as shown in FIG. 2 or two rollers as shown in FIG. 3. The number of rollers 110 is not an important feature of the present invention. The invention could include 1 roller 110. Each of the rollers 110 may be connected from the interior of one of the heightened walls 101 to the interior of the opposite heightened walls 101. The rollers 110 may be designed to spin when frictionally engaged with the footwear 200 or foot. It should be appreciated that reference made to footwear 200 should also include the foot of a user if the user is not wearing footwear. The rollers 110 may alternatively be ball bearings. The rollers 110 may be configured to activate a sensor 111 which is present within one of the heightened walls 101 of the housing 103 detects the presence of a foot or footwear 200 within the housing 103 of the device. The rollers 110 may be configured to employ a contact sensor (not shown). There may also be a pressure contact sensor (not shown) on the rollers 110 which operate to activate the valve 128, described in more detail below, when pressure is placed on the roller 110 by the footwear 200. A person of ordinary skill in the art would understand the type of contact sensor which could be employed as part of the rollers 110.

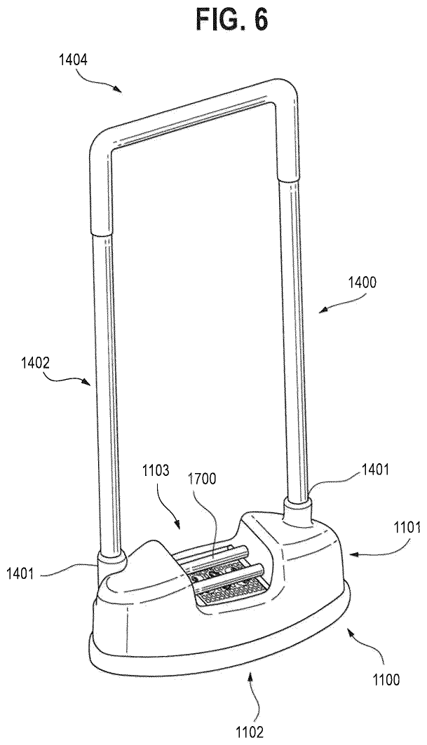

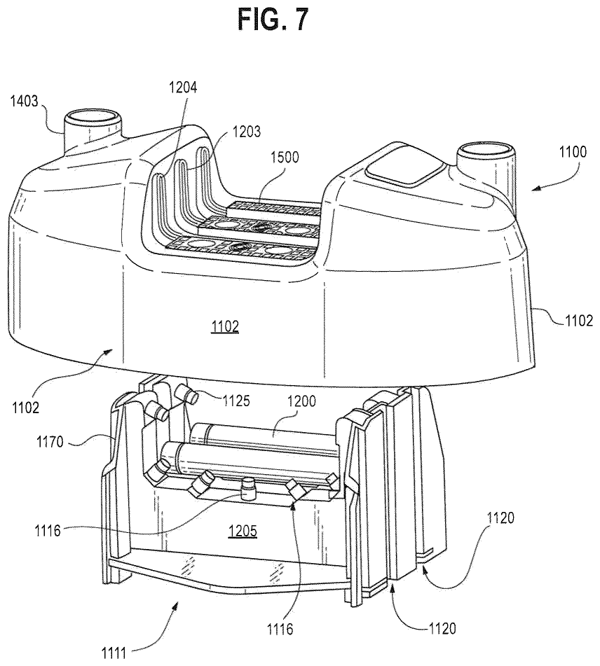

An alternative embodiment of the present invention is shown in FIGS. 6-9. In the alternative embodiment, the present invention embodies a protective cover 1100, with a protective area 1101 extending vertically from each side of the protective cover 1100, and a foot receiving wall 1102 on each adjacent side of the protective cover 1100. The protective cover 1100 is shown in an elliptical configuration, but any shape is desirable, so long as it can accommodate the foot of a user. The protective cover 1100 is configured in such a manner that the protective cover 1100 may be removable attached to base 1111 as shown in FIG. 7. The protective cover may include a handrail 1400 attached to the protective cover 1100, two receiving portions 1401 of the protective cover 1400. The receiving portions 1401 of the protective cover 1100 are configured to receive a support structure 1402 which can be inserted into the receiving portion 1401 of the protective cover 1110. The support structure 1402 of the handrail 1400 may be affixed to, or be integral with, the receiving portion 1401 of the protective cover 1400 by means of a set screw 1403 in the receiving portion 1401 of the protective cover 1400. The set screw 1403 can the tightened to exert a force on the support structure of the handrail 1402. While a set screw is shown in the preferred embodiment, it should be understood that other attachment means, such a screw being inserted into the support structure 1402 to engage the support structure, or a pin joint (not shown) could be engaged with a hole in the receiving portion 1401 of the protective cover 1400. This type of pin joint uses a spring-loaded button that snaps into a hole in the mating tube, creating a secure connection that can be easily released by pressing the button.

The support structure 1402 of the handrail 1400 is attached to a handle portion 1404. The handle portion is configured to permit a used to grasp the handle portion 1404 of the handrail 1400 while placing the user's foot in the device.

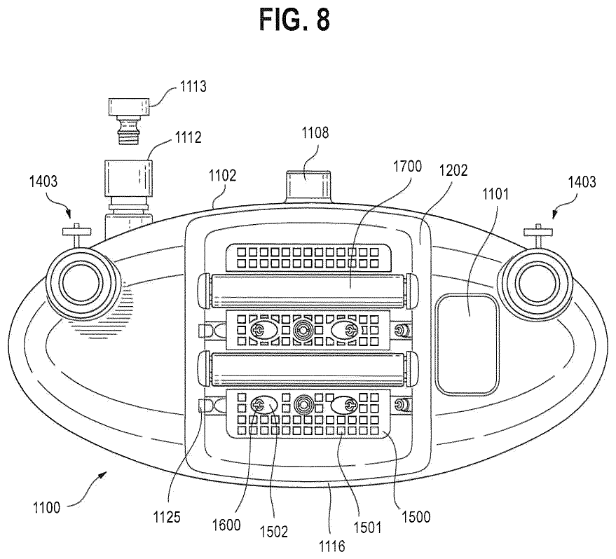

The protective cover 1100 comprises the foot receiving area 1103. The foot-receiving area 1103 is shown as rectangular in FIGS. 7 and 8. It should be understood that the protective cover 1100 may be manufactured in any shape and may also be configured to accommodate decorative elements if it is so desired. The protective cover 1100 may be made out of plastic, PVC, rubber, metal or any other suitable material that is capable of withstanding the demands of the cleaning device. It should be applicated by those of ordinary skill in the art that the protective cover 1100 may be constructed from one unitary piece from an injection molding process, or the protective cover 1100 could be constructed of numerous components. The protective area 1101 extending vertically from each side of the protective cover 1100 and the foot receiving wall 1102 may be configured to accommodate decorative panels. A manufacturer can place its own logo on the decorative panel, or the decorative panel can be used for advertising purposes.

The protective cover 1100 may also encompass grates 1500 for the purpose of protecting from debris falling in the sunken basin 1200 as a result of the cleaning process. The grates 1500 are configured in a grid to provide a honeycomb type 1501 of opening in the grate 1500 that allows water of liquid to enter the sunken basin 1200 while protecting from debris falling in the sunken basin 1200 as a result of the cleaning process. The grate 1500 also includes nozzle openings 1502 to accommodate the nozzles 1600 of the device and not interrupt the flow of water from the nozzles 1600 to the shoe or foot for cleaning. The grate 1500 should be configured to be removeable from the protective cover 1100 to allow access to the sunken basin 1200 and nozzles 1600, without having to remove the base 1111 from the protective cover 1100.

The protective cover 1100 has a protective area 1101 and foot receiving wall 1102 which form a foot receiving area 1103. In the foot receiving area 1103 there is the grate 1500 and rollers 1700. The foot receiving wall 1102 and protective area 1101 form the foot receiving area that has interior surface 1201 and 1202. The interior surfaces 1201 and 1202 include slots 1203 and 1204 to receive the rollers 1700. The slots 1203 and 1204 allow for the rollers 1700 to slide out of the protective area 1101 when the protective cover is removed from base 1111. The slots 1203 and 1204 may also accommodate one or more nozzles 1600. The rollers 1700 a positioned above the grate 1500 to provide that debris does not enter the operating portion of the device.

The protective cover 1100 may also include a solar panel 1800. The solar panel 1800 may be configured to charge an internal battery (not shown) that operates to supply power to the pump that operates to propel water from the nozzles 1600.

Base 1111 includes a sunken basin 1200 as shown in FIG. 7. Base 1111 may be removed from the protective cover 1100. As shown in FIGS. 7-9, the base is configured to slide into the protective cover through a quick connect mechanism. In the embodiment of FIG. 7, the quick connect mechanism comprises a series of slotted grooves 1120 or ridges. The slotted grooves 1120 or ridges of the base mate with a series of slotted grooves 1122 or ridges in the protective cover 1100. There may be a frictional engagement between the slotted grooves 1120 or ridges of the base 1111 and the slotted grooves 1122 or ridges of the protective cover 1100. The frictional force between the engagement of the slotted grooves 1120 or ridges of the base 1111 with the slotted grooves 1122 or ridge in the protective cover 1100 hold the protective cover 1100 in relation to the base 1111. The base 1111 may include a screw 1140 to connect the base 1111 to the protective cover 1100. The screw 1140 may be removed to allow the base 1111 to be removed from the protective cover 1100. Removal of the base 1111 form the protective cover 1100 to allow for easy repair of the nozzles 1600 and cleaning of any debris that may get in the catch pan 2105.

Turning to FIGS. 7 and 8, the sunken basin 1200 is part of or affixed to the removeable base 1111. Base 1111 includes a sunken basin 1200 that may be removably attached to base 1111 or may be integral with base 1111. The sunken basin 1200 includes a catch pan 2105. The sunken basin may include two nozzle walls 1170.

It is possible to place a filter in the catch pan 2105 to separate particulates from the water. Base 1111 may also include a cleanout opening 1108 facing horizontally and outwardly from the exterior of the catch pan 2105 of base 1111. Base 1111 may be elevated from the ground by tabs 1109. The tabs 1109 may be plastic, rubber or the same material. The catch pan 2105 may be angled in a direction that will enable water to flow towards drain 1108.

A plurality of rollers 1700 can be seen in FIGS. 6, 7 and 8. A plurality of rollers 1700 may be attached to the inside the nozzle walls 1170 in a plurality of horizontally parallel intervals. The rollers 1700 may be positioned along the nozzle wall 1170. While two rollers 1170 are shown in the preferred embodiment, it should be appreciated that the number of rollers 1700 is not limited to the two rollers as shown in FIGS. 6,7 and 8. The number of rollers 1700 is not an important feature of the present invention and the invention may operate with one roller 1700. Each of the rollers 1700 may be connected from the nozzle wall 1170 to the interior of the opposite nozzle wall 1170. The rollers 1700 may be designed to spin when frictionally engaged with the footwear 200 or foot. It should be appreciated that reference made to footwear 200 should also include the foot of a user if the user is not wearing footwear. The rollers 1700 may alternatively be ball bearings. The rollers 1700 may be configured to activate a sensor (shown in FIG. 1) which is present within one of the nozzle walls 1170 of the base 1111. The sensor 126 detects the presence of a foot or footwear 200 within the foot receiving area 1103 of the device. The rollers 1700 may be configured to employ a contact sensor. There may also be a pressure contact sensor on the rollers 1700 which operates to activate the valve (128 in FIG. 1), described in more above, when pressure is placed on the roller 1700 by the footwear 200. A person of ordinary skill in the art would understand the type of contact sensor which could be employed as part of the rollers 1700.

Base 1111 may also include one or more sole sprayers 1125 configured to spray water in a position along the side sole of the footwear 200 or foot. The sole sprayers 1125 are configured to be positioned on the nozzle walls 1170. The sole sprayers 1125 are positioned on the opposite side of the foot receiving area to direct a spray of water along the sole of footwear 200. It is important that the spray from the sole sprayer 1125 spray the sole of the footwear 200 and not actually spray the upper part of the footwear 200 with water. It is not desirable to spray the upper part of the footwear in a manner that would soak the upper portion of the footwear 200. Although not required, the sole sprayer 1125 nozzle is typically positioned to spray in an angled-downward direction so as to prevent the water from contacting the top surface of the footwear 200. The sole sprayers 1125 are positioned in base 1111 in proximity to the catch pan 1205. Water from the sole sprayer 1125 is directed toward the sole of the footwear 200 and is directed down into the catch pan 2105.

The device may encompass an option to provide a feature that cleans the top surface of a foot placed in the device. This option may be used at beaches, swimming pools or other areas that it is desirable to clean the top surface of the foot as well as the bottom and sides of the foot.

The embodiment shown in FIGS. 7-9 also includes a bottom sprayer 1116 that is configured to spray water toward the bottom portion of footwear 200. All the bottom sprayer 1116 operates to remove debris from the bottom of the sole of the footwear 200 or foot. The bottom sprayers 1116 are positioned in base 1111 in proximity to the catch pan 2105. Water from the sole sprayer 1125 is directed toward the sole of the footwear 200 and is directed down into the catch pan 2105.

All the bottom sprayer 1116 may operate to remove debris from the bottom of the sole of the footwear 200 or foot. The bottom sprayer 1116 may be positioned between the rollers 17000 so that the rollers 1700 do not interfere with the bottom sprayer 1116 directed toward the sole of the footwear 200.

The embodiment of FIGS. 6-9 encompass a plurality of rollers 1700 that support the sole of the footwear 200 or the base of the foot. The bottom sprayer 1116 may include numerous spray nozzles 1600 if desired. The bottom sprayers 1116 are positioned in a fashion that the roller 1700 does not interfere with the water jet propelled through the bottom sprayers 1116. The bottom sprayers can be placed in numerous different configurations which operate to clean the footwear 200. The bottom sprayers 1116 are positioned such that the bottom sprayers direct water through the opening 1502 in the grate 1500. The bottom sprayers 1116 are positioned to direct the flow of water to the bottom surface of the footwear 200 allowing the water to flow back into the catch pan 2105 such that water does not escape the foot receiving area 1103. It is preferred that the bottom sprayer 1116 be positioned below the grate 1500 such that the bottom sprayer 1116 is protected when a user inserts the footwear 200 into the foot receiving area 1103 of the device. The bottom sprayer 1116 could be positioned above the grate 1500 without departing from the spirit of the invention.

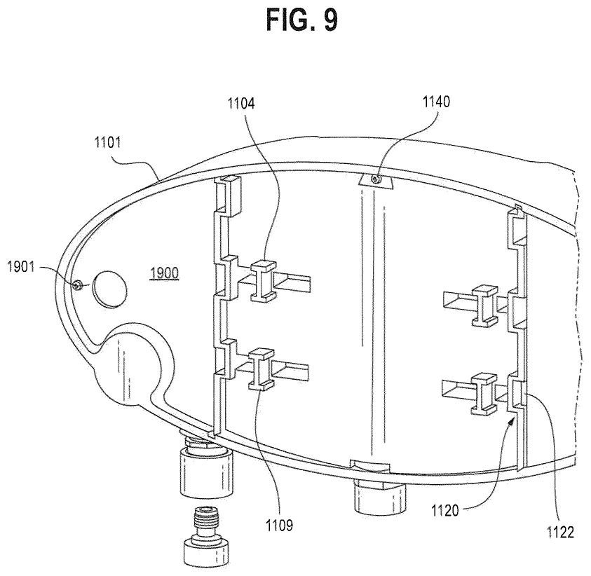

As shown in FIG. 9 the bottom portion of the protective cover 1100 includes a water supply access panel 1900. The water supply access panel 1900 allows access to each of the first 114, second 117 and third 121 water line extensions may at least a first spray nozzle 116, a second spray nozzle 118, and a third spray nozzle 119 (as depicted in FIGS. 1 and 2) but can include numerous spray nozzles if desired. The access panel 1900 also allows access to sole sprayers 1125 and sole sprayer 1116 and as well as the first, second and third water line extensions While the drawings show three water lines each having one or more sole sprayers 1125 and bottom sprayers 1116 at each end, the water lines can be placed in numerous different configurations which operate to clean the footwear 200. The access panel 1900 may be rotatably fixed to the proactive cover 1100 by means of a hinge and affixed to the protective cover by an access panel screw 1901. The protective cover 1100 may be fixed to the base 1111 by a fastener 1140 such as a screw. A latch of other fasting mechanisms may be use without departing from the spirit of the invention.

The above description is not intended to limit the meaning of the words used in or the scope of the following claims that define the invention. Rather the descriptions and illustrations have been provided to aid in understanding the various embodiments. It is contemplated that future modifications in structure, function or result will exist that are not substantial changes and that all such insubstantial changes in what is claimed are intended to be covered by the claims. Thus, while preferred embodiments of the present inventions have been illustrated and described, one of skill in the art will understand that numerous changes and modifications can be made without departing from the claimed invention. In addition, although the term “claimed invention” or “present invention” is sometimes used herein in the singular, it will be understood that there is a plurality of inventions as described and claimed. Although embodiments of the present invention have been described, those of skilled in the art will appreciate that variations and modifications may be made without departing from the spirit and scope thereof as defined by the appended claims.

What is claimed:

1. A footwear or a foot cleaning device comprising:
a protective cover having a first protective area, a second protective area and a first foot receiving wall and a second foot receiving wall forming a foot receiving area in the protective cover, wherein the height of the first protective area and second first protective area is configured to extend to a height above a footwear or a foot when the footwear or the foot is placed in the device to encompass the footwear or the foot within the foot receiving area;
a base configured to be removably engaged by the protective cover wherein the base includes a plurality of nozzle walls;
a catch pan defined within the base, wherein the catch pan is configured to collect water and debris, the catch pan includes a drain;
a grate position on the foot receiving area above the catch pan;
a plurality of rollers affixed to the nozzle walls, wherein the plurality of rollers define a contact axis formed by a sole of the footwear or the foot wherein the contact axis extends between the plurality of nozzle walls;
a water inlet positioned affixed to the protective cover including a valve;
a sole water line extension positioned on one of the nozzle walls, the sole water line includes a sole water spray nozzle positioned above the contact axis configured to spray a stream steam of water, wherein the sole water spray nozzle is adapted to spray in a direction such that the spray directly contacts the sole of a footwear or the foot that when positioned in the foot receiving area;
a bottom water line extension positioned in the catch pan the bottom spray nozzle positioned below the contact axis and configured to spray a stream of water, wherein the bottom water spray nozzle is adapted to spray in a direction such that the spray directly contacts the bottom portion of the sole of a footwear or the foot when positioned in the foot receiving area;
a sensor positioned in the foot receiving area to detect the presence of the footwear or the foot in the footwear receiving area of the housing, wherein the sensor is configured to be activated by the presence of the footwear or the foot, whereupon activation of the sensor, the sensor sends an activation signal to activate a solenoid connected to the valve to operate to operate the valve and allow water to the sole water spray nozzle, to the side water spray nozzle and the base spray nozzle until the footwear or the foot is removed from the footwear receiving area.

2. The footwear or the foot cleaning device of claim 1, further comprising a handrail; a receiving portion configured in the protective cover wherein the handrail is affixed to the receiving portion of the protective cover.

3. The footwear or foot cleaning device of claim 1, wherein the grate is removeable.

4. The footwear or foot cleaning device of claim 3, the grate has holes in proximity of the bottom nozzles configured to allow the spray of the bottom spray nozzle to pass through the hole in the grate.

5. The footwear or the foot cleaning device of claim 1, further comprising a power supply positioned in the protective cover; a pump positioned in proximity to the sole water line and the bottom water line to increase the pressure in the water line wherein the power supply provides power to the pump.

6. The footwear or the foot cleaning device of claim 5, wherein the power supply comprises a battery.

7. The footwear or the foot cleaning device of claim 6, further comprising a solar panel positioned on the protective cover, wherein the solar panel supplies electrical current to the battery.

8. The footwear or foot cleaning device of claim 1, wherein the sensor is a pressure switch is configured to cooperate with one or more of the plurality of rollers.

9. The footwear or the foot cleaning device of claim 8, wherein the sensor is a pressure sensor that operates to activate the valve to open the valve until pressure from the footwear or foot is removed from one of the plurality of rollers.

10. The footwear or the foot cleaning device of claim 1, wherein the sensor is a photocell.

11. The footwear or the foot cleaning device of claim 10, wherein the sensor is configured to open the valve for a predetermined period of time after the sensor detects the presence of the footwear or the foot in the footwear receiving area to activate the sole water spray nozzle and the bottom water spray nozzle.

12. The footwear or the foot cleaning device of claim 1, wherein the sole water spray nozzle and bottom water spray nozzle are positioned to maintain the water directed from the sole water spray nozzle and the side water spray nozzle within the footwear receiving area.

13. The footwear or the foot cleaning device of claim 1, further comprising a drain in the catch basin configured to extract water from the basin

14. The footwear or the foot cleaning device of claim 11, further comprising a filter positioned within the catch pan.

15. The footwear or the foot cleaning device of claim 1, further comprising a quick connect mechanism on the protective area; a quick connect mechanism on the base; wherein the quick coupling mechanism comprises a series of slots that mate with a series of grooves which impart a frictional force on each other.

16. The footwear or the foot cleaning device of claim 15, further comprising a screw to connect the base to the protective cover.

17. The footwear or the foot cleaning device of claim 1, further comprising a screw to connect the base to the protective cover.

18. The footwear or the foot cleaning device of claim 1, further comprising an access door on the protective cover wherein the access door provides access to the sole water line extension.

19. The footwear or the foot cleaning device of claim 18, wherein the access door on the protective cover provides access to the bottom water line extension.

20. The footwear or the foot cleaning device of claim 1, wherein the plurality of rollers includes a bristle portion for cleaning the bottom of the footwear or foot.
